(19) United States
(12) Patent Application Publication
(10) Pub. No.: US 2003/0061276 A1
(43) Pub. Date: Mar. 27, 2003

(54) Method and apparatus to determine operation of software

(76) Inventor: Charles Albert Mirho, Vancouver, WA (US)

Correspondence Address: Charles A. Mirho, 112 West 37th Street, Vancouver, WA, 98660, US

(21) Appl. No.: 09/962,988

(22) Filed: Sep. 26, 2001

(51) Int. Cl. G06F 15/16

(52) U.S. Cl. 709/203; 709/205; 705/14

(57) ABSTRACT

A method includes altering operation of software and prompting a user of the software for information. The information is communicated to a server via a request message. Operation of the software is restored as a result of a response message received from the server.

### FIELD

The invention is directed towards software, and, more particularly, to determining the operation of software.

### BACKGROUND

Modem computer systems are often coupled together into “networks”, e.g. groups of computers which may share information with one another. Networked computers may be coupled using various technologies well known in the art, including but not limited to electrical and metallic lines, fiber optic cables, and wireless technologies such as radio frequency (RF) and infrared. A computer or computer system is any device comprising a processor coupled to a memory, the memory capable of storing signals representing instructions to the processor and data. The processor may access memory and carry out, e.g. “execute”, the instructions to transform or otherwise operate upon the data, in manners well known in the art.

A typical computer network may comprise one or more computer systems operating as network “clients”, and one or more computer systems operating as network “servers”. A “server” computer system may supply, upon request, operations and/or data to a “client” computer system. The server typically supplies operations and/or data by executing one or more instructions in response to signal(s) from a client, and by making the results available to the client by way of the network, in manners well known in the art. A particular computer system of a network may operate as either a client, a server, or both, depending upon the circumstances. When a client computer makes a request to a network server, the network server is said to be experiencing “traffic” from the client. Traffic to a server increases as more clients submit more requests to the server.

A computer system may need to “connect” to a network before exchanging signals with other computer systems on the network. Establishing a connection to the network may involve placing the computer system into a state in which it may communicate, e.g. exchange signals with, with other computer systems on a network. Connections may be established in many manners which are well known in the art. For example, a computer system located in a building operated by a business entity may connect to a server within the same building by sending signals over wiring within the building. Such a computer network may be referred to as a “local area network” or an “intranet”. To connect to the well-known Internet computer network, a first computer system located in a residential home or small business may “dial up” a second computer system, which in turn provides access to the Internet network. This may be referred to as a “dial up connection” and may involve the first computer system providing a phone number to a public or private telephone network, resulting in a connection being established between a modem operated by the first computer system and a modem operated by the second computer system, in manners well known in the art. The first computer system may communicate with computer systems of the Internet network by way of this connection. Many other manners of establishing connections between a computer system and a network may be apparent to those skilled in the art, and all are generally applicable to the present invention.

Computer systems may store software comprising one or more instructions and data. Data refers to signal values stored in memory which are typically not executed, but which may affect, be altered by, or be generated by the execution of instructions. Instructions, together with data, may define operations (results of executing the instructions) to be performed by a computer system. Instructions and data may be organized and/or packaged in a manner suitable for distribution to other computer systems. For example, instructions and data may be organized into executable programs, software libraries (both statically and dynamically linked), applets, applications, ActiveX™ controls, component object model (COM) components, interpreted scripts, and many others. Of course, software is highly adaptable and the “boundaries” between instructions and data may be indistinct.

Instructions and data may define many types of operations. For example, instructions and data might define an operation to calculate the slope of a line, or to display a pixel on a display device associated with the computer system, or to establish a connection to a network. Data which, together with one or more instructions, defines an operation, may be referred to as an “attribute” of the software comprising the instructions. An attribute may comprise a single memory location or multiple memory locations. Again, the distinction between data and instructions is often difficult to realize in practice, and attributes of software may comprise combinations of instructions and data, possibly comprising multiple memory locations storing multiple data and instruction signals.

“Execution” of software means execution of at least one instruction of the software.

To protect the time and investment made in developing software, the software may be “time bombed”. Time bombing typically involves disabling execution of the software a predetermined time after the software is downloaded, installed, or first used on the client computer system. Another technique is the two-version approach, by which two versions of the software may be provided. One version may be provided for free (zero priced) and another version may be made available only after payment is made. Both of these techniques are directed toward allowing a customer to experiment with and test the software on a no-charge basis, but to later obtain value (typically in the form of monetary payment) should the customer wish to continue executing the software on an ongoing basis.

In a variation of the two-version approaches, operation of software may be disabled after executing the software a predetermined number of times. For example, software may comprise operations to calculate a mortgage payment. Such operations may be initially made available free of charge. However, after the operations are performed a predetermined number of times (say, ten), the operations are disabled so that it may no longer be use the software to calculate a mortgage payment. The user of the software may be encouraged to make payment to restore the mortgage calculation operations.

Other approaches for obtaining value for the operations of software include the “pay per use” and “pay per minute” approaches. Under these approaches, a user of the software is billed according to a number of times an operation is performed, or according to an amount of time over which the software is available for use or actually used. Of course, the billing could be applied according to units of time other than a “minute”—for example, seconds, hours, or days. In a variation of the pay-per-use approach, some or all of the operations of software may be disabled after the operations are performed a predetermined number of times. For example, consider again the software to calculate a mortgage payment. Operations of the software may be available initially free of charge. However, after the software is executed a predetermined number of times, execution may be disabled. The user of the software may then be encouraged to make payment to enable the mortgage calculation object to be executed another ten times.

The pay-per-minute and pay-per-view approaches are similar to the time-bomb and two-version approaches, in that each is directed toward obtaining value from the user for operations of the software. However, none of these approaches take advantage of the value which may be obtained by determining the operation of the software based upon increasing interaction with a user of the software. Determining the operation of the software in a manner which increases interaction with a user of the software may be valuable, for example, to build a customer relationship.

### SUMMARY

A method includes altering operation of software and prompting a user of the software for information. The information is communicated to a server via a request message. Operation of the software is restored as a result of a response message received from the server.

### FIGURES

The invention may be better understood with reference to the following figures in light of the accompanying description. The present invention, however, is limited only by the scope of the claims at the concluding portion of the specification.

FIG. 1 shows a system embodiment in accordance with the present invention.

FIG. 2 shows an embodiment of a user interface in accordance with the present invention.

FIG. 3 shows an embodiment of a message in accordance with the present invention.

FIG. 4 shows an embodiment of a message in accordance with the present invention.

FIG. 5 shows an embodiment of a user interface in accordance with the present invention.

FIG. 6 shows an embodiment of a message in accordance with the present invention.

FIGS. 7 and 8 show embodiments of a response message from the receiving device to the client device.

FIG. 9 shows an embodiment of a response signal in accordance with the present invention.

FIG. 10 shows an embodiment of a response signal in accordance with the present invention.

FIG. 11 shows an embodiment of a client device in accordance with the present invention.

FIG. 12 shows a server device embodiment in accordance with the present invention.

FIG. 13 shows embodiments of data tables in accordance with the present invention.

FIG. 14 shows a method embodiment in accordance with the present invention.

### DESCRIPTION

In the following description, numerous references to “one embodiment” or “an embodiment” do not necessarily refer to the same embodiment, although they may. In the figures, like numbers refer to like elements.

Those skilled in the art will appreciate that the methods of the present invention herein described may be embodied in software, hardware, firmware, carrier waves, or any combination thereof. Operations of the present invention may be implemented in a high level procedural or object oriented programming language and/or assembly or machine language, if desired. In fact, the invention is not limited in scope to any particular programming language. The language may be a compiled or interpreted language. Operations of the present invention may be embodied in software comprised by a digital storage media (e.g., hard disk, floppy disk, read only memory (ROM), CD-ROM, flash memory, digital versatile disk (DVD), or other storage media) readable by a general or special purpose programmable processing system, for configuring and operating the processing system to perform embodiments of the procedures described herein.

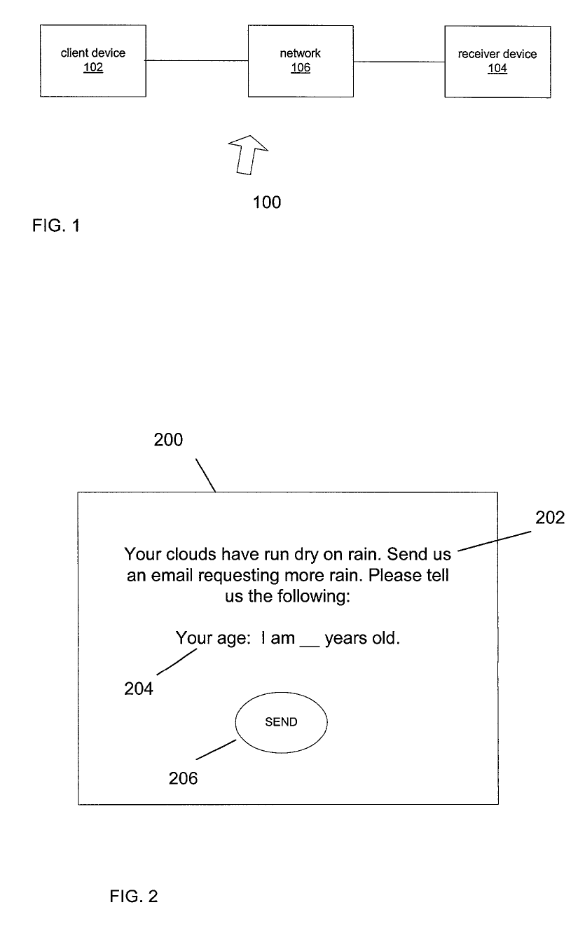

FIG. 1 shows a system embodiment 100 in accordance with the present invention. Embodiment 100 comprises a client device 102 coupled by way of a network 106 to server device 104 by way of a network 106. A server is any device which responds to with data and/or instructions to requests from one or more clients. The client device 102 and server device 104 may be any devices capable of executing software, e.g. any device comprising a memory for storing instructions and data to be supplied to a processor of the device. Exemplary client devices include personal computers, an Internet or network appliance device, a set-top box, a hand-held computer, a game player, a personal digital assistant, a personal and portable device for displaying animations, and portable communication devices. Exemplary server devices include microprocessor-based computer systems, midrange systems comprising a plurality of microprocessors, mainframes, and clusters of cooperating computers running Microsoft® Windows® and/or variants of the Unix operating system. The network 106 may comprise any interconnection mechanism by which the client device 102 may communicate with the server device 104. For example, the network 106 may be a local area network (LAN), a wide area network (WAN), the Internet, a public telephone network, and a satellite or other wireless communications network. One or more network interface devices (not shown) may couple to the client device 102, server device 104, and the network 106.

The client device 102 may comprise memory for storing instructions and/or data. The memory may comprise any machine-readable media technology, such as Random Access Memory (RAM), Dynamic RAM (DRAM), Read-Only Memory (ROM), a hard drive, flash memory, cache memory, and so on. The memory may store instructions and/or data that may be executed and/or operated upon by a processor of the client device 102 to perform techniques of the present invention. The memories of the client device 102 and server device 104 may also contain additional instructions and/or data which is not necessary to the understanding and/or practice of the present invention.

FIG. 2 shows an embodiment 200 of a user interface in accordance with the present invention. According to embodiment 200, a user of software is provided with a prompt 202 indicating that a resource of the software is depleted. As a result of depletion of the resource, operation of the software may be altered. For example, if the software provides a simulation of clouds with rain, the simulation of rain may deplete a resource of the software, such that after a certain number of rainfalls (or after a certain amount of rain has fallen, etc.), the software will no longer produce simulated rain unless the rain resource is restored. The prompt 202 indicates that the user should provide information which may be transmitted via an email message or other signal to the server device 104 in a request to restore the resource. The specific information which should be provided is indicated by prompt 204. The user may then provide the requested information to the interface 200. An email or other signal requesting refreshment of the resource and including the provided information may then be generated and communicated via the network 106 to the server device 104. Generation and communication of the request signal may occur in response to selection of control 206, or automatically after the user enters the requested information. If the client device is not currently on-line (e.g. able to communicate with the server 104 via the network 106), the request signal may be stored and communicated to the server 104 at a later time. A response signal in the form of an email or other signal may then be generated by the server 104 and communicated to the client 102. The response signal may contain data and/or instructions which, when applied to the software, replenishes the depleted resource. As a result, operation of the software may be restored.

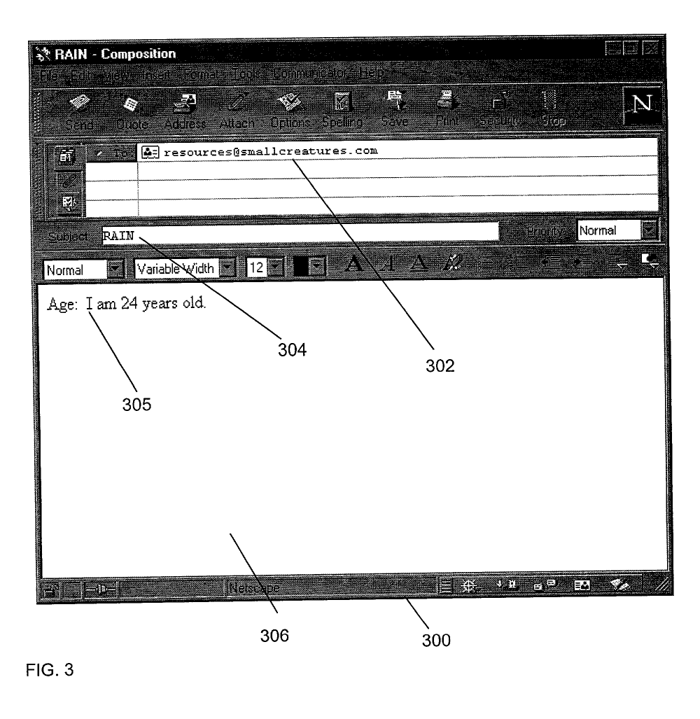

FIG. 3 shows an embodiment 300 of a message in accordance with the present invention. The message 300 comprises a network address 302 to which the message may be communicated. Of course, the network address 302 may vary both in content and in format according to different network addressing schemes. The resource to replenish 304 is identified in the subject line of the message, which may be an email message or other signal. In embodiment 300 the resource to replenish is identified as “RAIN”. By identifying the resource in the subject line, it may be possible for the server 104 to automatically (without the intervention of a person) identify the resource is involved in the request, and to automatically respond to replenish the resource. The information 305 provided in response to the prompt 204 is provided in the body 306 of the message. This information 305 may be recorded by the server 104 so that over time a database of information may be built up from multiple replenishment requests from a particular software user.

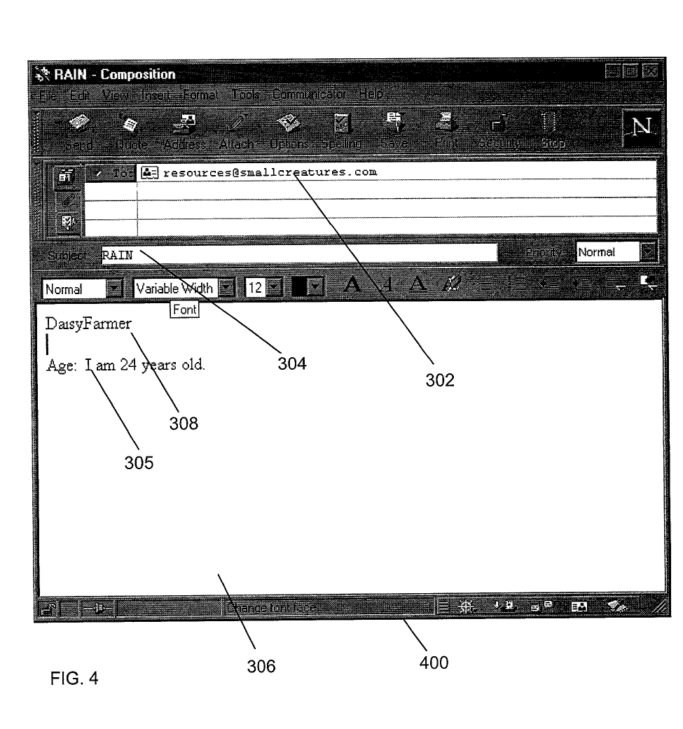

FIG. 4 shows an embodiment 400 of a message in accordance with the present invention. A user identification 308 is included in the body 306 of the message, which may be an email message or other signal. The user identification 308 identifies the user of the software for which replenishment of a resource is requested. Identifying the user in the body of the message may simplify the correspondence of the request and the provided information 305, so that over time a database of information may be built up from multiple replenishment requests from a particular user. The present invention may be used to collect any type of information from a user of software, including demographic information.

Alternatively, the user who sent the request may be identified using the “From” field of the message. One problem with this approach is that over time the user may send requests from different accounts on different servers, so that the “From” address may not be consistent among requests from a same user.

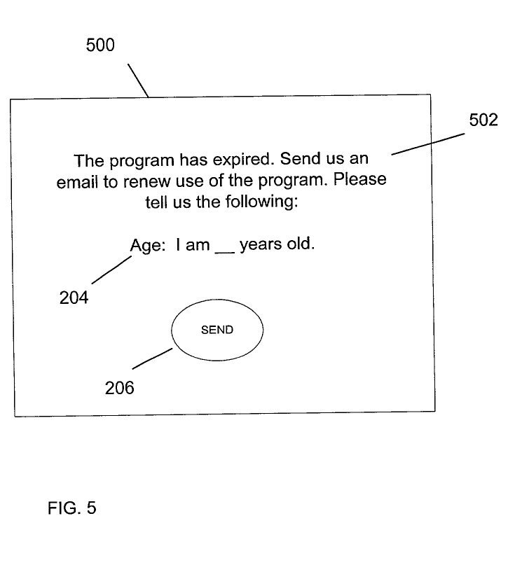

FIG. 5 shows an embodiment 500 of a user interface in accordance with the present invention. According to embodiment 500, a user of software is provided with a prompt 502 indicating that use of the software has expired. For example, if the software provides for up to thirty days of use, the software may cease to operate, or operate in a more limited or less desirable fashion, after the thirty days are up. Of course, the software could also provide for a number of uses, or expire according to some other metric. The prompt 502 indicates that the user should provide a request message to restore the operation of the software. The prompt also indicates that additional information, perhaps in the form of demographic information about the user of the software, should also be provided in the message. The specific information which should be included is indicated by prompt 204. The requested information may be entered into prompt 204. A message requesting restoration of operation of the software and including the provided information may then be generated and communicated via the network 106 to the server 104. Generation and communication of the message may occur in response to selection of control 206, or automatically. Of course, if the client device is not currently on-line, the message may be stored and communicated at a later time. A response message in the form of an email or other signal may then be generated and returned by the server 104. The response signal may contain data and/or instructions which, when applied to the software, restores the operation of the software.

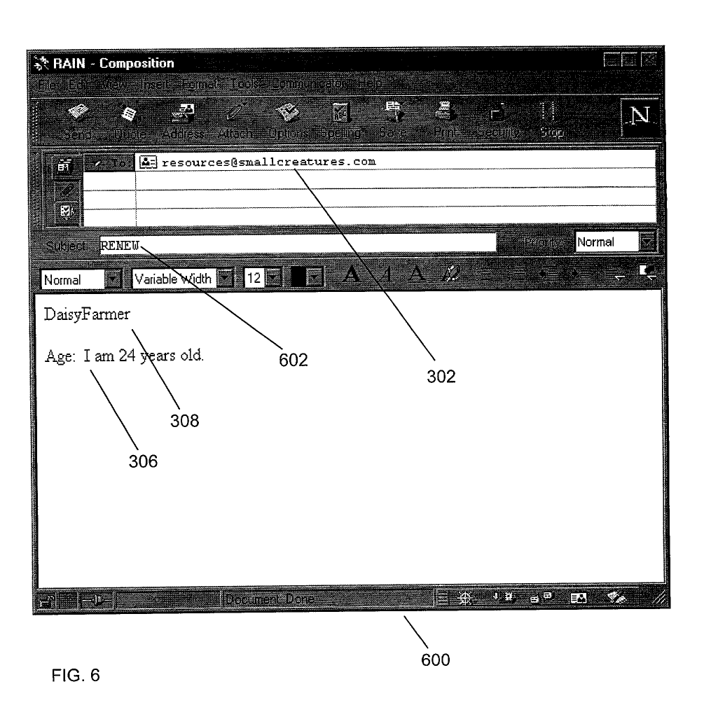

FIG. 6 shows an embodiment 600 of a message in accordance with the present invention. The message 600, which may take the form of an email or other signal, comprises a network address 302 to which the message is communicated. The network address 302 may vary both in content and in format according to different embodiments. The subject 602 of the message indicates that restoration of the operation of the software is requested. In embodiment 600, the request for restoration of the operation of the software is identified by the subject “RENEW”. It may be possible for the server 104 to automatically respond with instructions and/or data to restore the operation of the software. The information 305 provided in response to the prompt 204 is provided in the body 306 of the message. This information 305 may be recorded by the server 104 so that a profile and/or database for the user of the software may be built up over time, as additional renewals are requested.

A user identification 308 is included in the body 306 of the message. The user identification 308 identifies a user of the software for which replenishment/renewal of a resource is requested. Identifying the user in the body of the message may simplify the correspondence of the user and the provided information 305.

Alternatively, the user who sent the request may be identified using the “From” field of the message. One problem with this approach is that over time the user may send requests from different accounts of different messaging servers, so that the “From” address for a same user may not be consistent between requests.

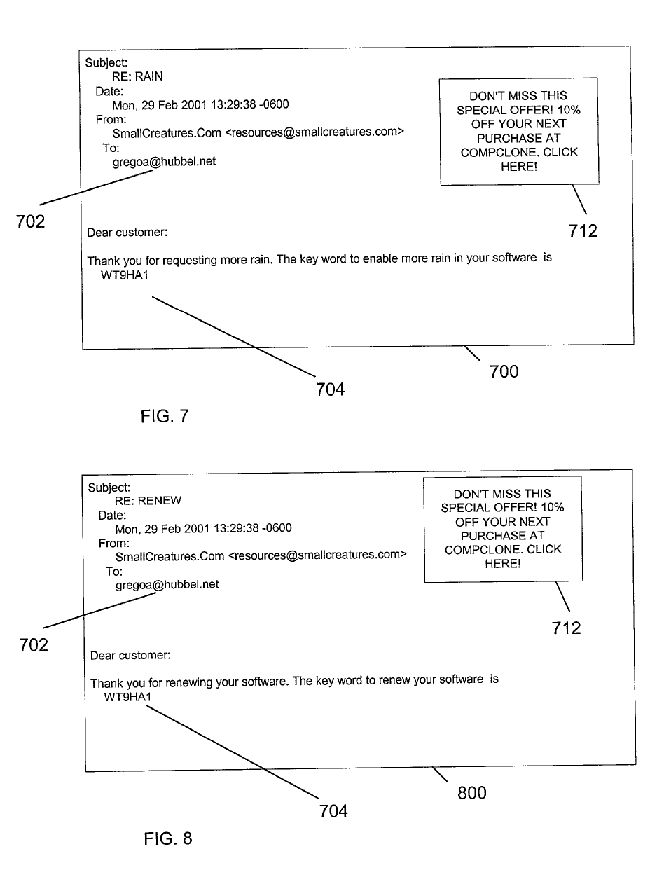

FIGS. 7 and 8 show embodiments 700 and 800, respectively, of a response message from the server 104 to the client 102. Referring to embodiment 700, the response message is addressed 702 to the user of the software. The response address 702 may comprise the “From” or “Reply” address of the request message. Data 704 is provided in the message 700. This sequence may be applied to the software to effect the restoration/renewal of the depleted resource. The subject of the message identifies the resource, e.g. “RAIN”, for which the data 704 may be applied (input, read, etc.) to the software effect restoration. In one embodiment, the software may generate data independently (e.g. without communication with) of the server and compare the independently generated data with the received data 704. For example, the software may perform any one of numerous well-known hashing, encoding, compression, and other methods on the information provided by the user in response to the prompt 204, or upon the prompt 204 itself, and compare this hash with the data 704. When the two data match, the software replenishes/renews the depleted resource.

The response message 700 may comprise an advertisement 712 to expose to the user of the software. The user may be exposed to the advertisement upon opening the response message 700, or upon a next execution of the software. The advertisement may comprise one or more of text, images, animations, sound (audio), video, and so on.

Embodiment 800 shows a similar message, sent in response to a request to restore the operation of expired software. The subject of the message, “RENEW”, indicates that the data 704 may be applied to restore operation of the expired software.

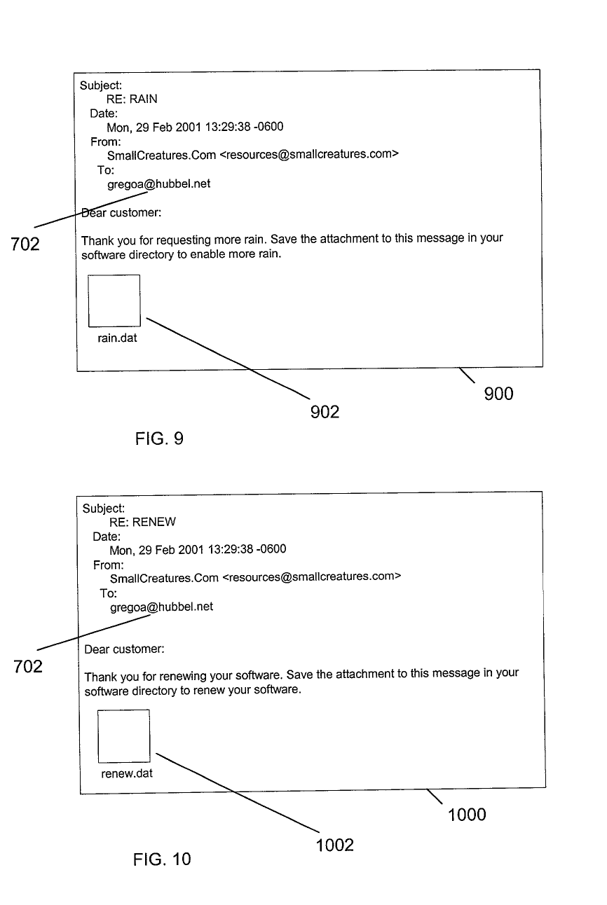

FIG. 9 shows an embodiment 900 of a response message in accordance with the present invention. The message 900 is provided in response to a request to replenish a resource of software. The message 900 comprises an attachment 902 comprising data and possibly instructions which, when applied to the software, results in replenishment of a depleted resource of the software. For example, the attachment 902 may be stored in a memory and/or mass storage location (directory, partition, etc.) accessible to the software comprising the resource to replenish. The software may access the data and/or instructions of the attachment 902 in order to effect replenishment of a depleted resource.

FIG. 10 shows an embodiment 1000 of a response message in accordance with the present invention. The message 1000 is provided in response to a request to restore the operation of software. The message 1000 comprises an attachment 1002 comprising data and possibly instructions which, when applied to the software to restore, results in restoration of the operation of the software. For example, the attachment 1002 may be stored in a memory and/or mass storage location (directory, partition, etc.) accessible to the software. The software may access the data and/or instructions of the attachment 1002 in order to effect restoration of operation of the software.

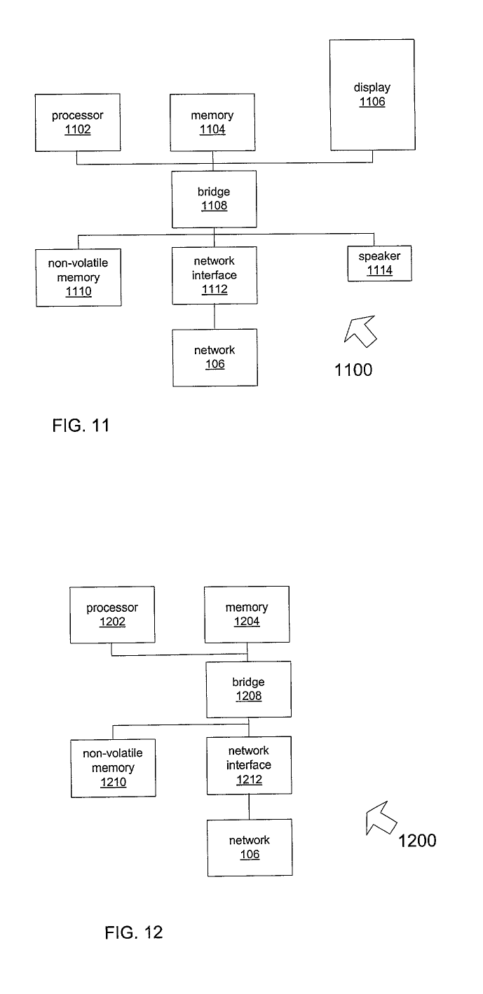

FIG. 11 shows an embodiment 1100 of a client device in accordance with the present invention. The embodiment 1100 comprises a processor 1102 coupled to a memory 1104. The memory 1104 stores instructions and data to supply to the processor 1102. The processor 1102 may execute the instructions to operate upon the data. Processor 1102 and the memory 1104 may be coupled by way of one or more buses. A bus bridge 1108 may couple the processor 1102 and memory 1104 to one input/output (I/O) devices. The I/O devices may be coupled to the bus bridge 1108 and possibly to one another by way of one or more buses, sometimes referred to as “I/O busses”.

Non-volatile memory 1110 may store instructions and data to carry out methods and operations in accordance with the present invention. In particular, the software stored by non-volatile memory 1110 may operate to deplete software resources, supply signals requesting replenishment or renewal of the resources, and to receive responses to replenish or renew the resources. The software stored by non-volatile memory may be loaded into the memory 1104 so that the instructions and data of the software may be supplied from memory 1104 to the processor.

The network interface 1112 communicates with one or more servers 104 by way of the network 106. Client 1100 includes a display 1106 for rendering signals into a visual format, for example, for rendering signals into images, video, and animation. The speaker 1114 comprises mechanisms to render signals into sound waves, for example, to render digital or analog audio signals into sound.

Some hardware and software components of the client embodiment 1100, as well as numerous well-known details, are not shown so as not to obscure the present invention. Of course, this is only one possible design of a client device, and many others are known in the art and within the scope of the present invention. Some client embodiments may comprise fewer features than those described, in the interest of economics and size reduction. For example, an embodiment of a portable consumer game player for children may not comprise a bus bridge or other components more common in larger, more expensive client devices.

FIG. 12 shows a server device embodiment 1200 in accordance with the present invention. The embodiment 1200 comprises a processor 1202 coupled to a memory 1204. The memory 1204 stores instructions and data to supply to the processor 1202. The processor 1202 may execute the instructions to operate upon the data. Processor 1202 and the memory 1204 may be coupled by way of one or more buses. A bus bridge 1208 may couple the processor 1202 and memory 1204 to one input/output (I/O) devices. The I/O devices may be coupled to the bus bridge 1208 and possibly to one another by way of one or more buses, sometimes referred to as “I/O busses”.

Non-volatile memory 1210 may store instructions and data to carry out methods and operations in accordance with the present invention. In particular, the software stored by non-volatile memory 1210 may operate to receive messages requesting replenishment or renewal of software resources and to respond accordingly. The software stored by nonvolatile memory may be loaded into the memory 1204 so that the instructions and data of the software may be supplied from memory 1204 to the processor.

The network interface 1212 exchanges signals with one or more client devices 102 by way of the network 106.

Some hardware and software components of the server embodiment 1200, as well as numerous well-known details, are not shown so as not to obscure the present invention. Of course, this is only one possible design of a server device, and many others are known in the art and within the scope of the present invention.

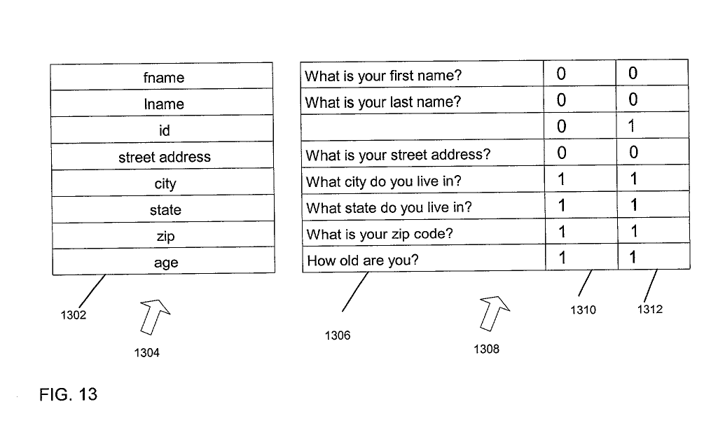

FIG. 13 shows embodiments 1304, 1308 of data tables in accordance with the present invention. Data tables are a manner of organizing and storing information and are well-known in the art. Data table 1304 includes fields such as age field 1302 comprising information, for example information about a user of software. Fields of table 1304 may have associated fields of table 1308. For example, age field 1302 of table 1304 may have associated fields 1306, 13130, and 1312 of table 1308. Field 1306 comprises a prompt which may be displayed to a user to providing information for an associated field of table 1304. For example, a prompt such as “How old are you” may be displayed to encourage a user to provide an age to be stored by field 1302. Field 1310 of table 1308 may comprise a data value to indicate whether a user has already provided the information for an associated field of table 1304. For example, a data value 1 of field 1310 may indicate that a user has already supplied information in response to the prompt “How old are you” during a present or previous access to the server, or that the information for the field was otherwise supplied. In one embodiment, once information to store in an associated field of table 1304 is provided, a user is not prompted for the information again.

Field 1312 may comprise a data value indicating that a response to an associated prompt is optional or required. For example, a data value of 1 in field 1312 may indicate that a response to the prompt “How old are you” is required. A data value of 0 in field 1312 may indicate that although the user may be prompted to provide information for an associated field of table 1304, providing that information is optional. In one embodiment, a data value of field 1312 other that those indicating a required and optional response may indicate that the user is not to be prompted to provide information for the associated field in table 1304. In one embodiment, fields of table 1304 for which a user will not be prompted to provide information have no prompt in the associated field 1306 in table 1308. In other words, the user may not be the source of information for the associated field of table 1304—the information for the field may be automatically generated, provided by a producer or distributor of the software, etc. Of course, many other techniques are possible for identifying a field as one for which a required response, optional response, or no prompt are associated and the manners discussed are only among many possibilities.

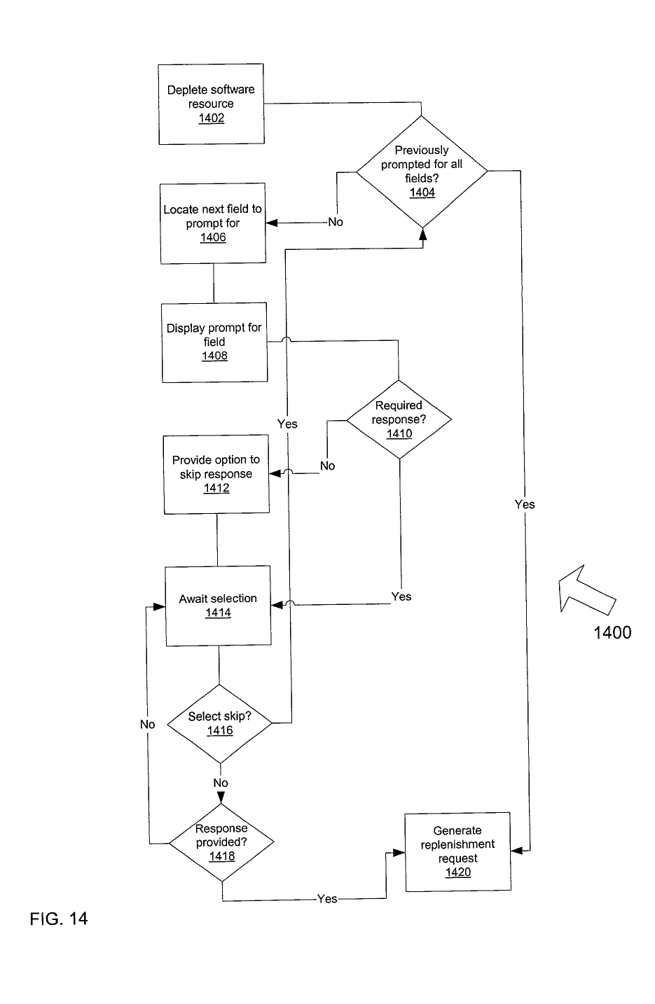

FIG. 14 shows a method embodiment 1400 in accordance with the present invention. At 1402 a software resource is depleted. At 1404, a check is made to determine whether all fields of a table for which prompts are to be made have been prompted for. If all such fields have been prompted for, a request to replenish the resource is generated at 1420. Otherwise a next field which has not been prompted for is located at 1406. Once a field which has not been previously prompted for is located, and for which a prompt is associated, the associated prompt is displayed at 1408. A check is made at 1410 to determine whether the field is a required field for which a response must be provided in order to replenish the resource. If a response is not required, the option to skip is provided at 1412. The selection of how to proceed is awaited at 1414.

If the response is required, the option to skip is not provided. If the selection to skip is made at 1416, then the determination at 1404 is again made. If a prompt has not provided for information for all fields for which prompts are associated, the next such field which has not been prompted for is located at 1406 and the prompt for that next field is provided at 1408. Providing of the prompt at 1408 may result in setting a data value indicating that the field has been prompted for. If no selection to skip the response was made at 1416, or if response is required, (in which case the option to skip would not have been presented at all), a determination is made at 1418 whether a response was provided to the prompt. If no response was provided, the method returns to awaiting the selection at 1414. If a response was provided to the prompt, the request to replenish the resource is generated at 1420.

In other words, a user may be prompted to provide first information in response to depletion of a resource. A subsequent depletion of the resource may result in prompting the user to provide alternate information. A selection is provided to skip providing the first information when providing the first information is optional. The user may be prompted to provide alternate information in response to a selection to skip providing the first information. When providing the information is required to replenish the resource, replenishment of the resource may be denied when the user does not provide information in response to the prompt. Once the user has been prompted for all information in a set of information (such as a table) and once the user has provided responses for all required information of the set, replenishment of the resource may be provided without prompting for information.

Thus, information may be collected from a user of software without relying upon long information forms. At different times when a user attempts to replenish a resource of the software, the user may be prompted to supply additional information.

In one embodiment, the resource which is depleted may be associated with game software, screen-saver software, and other software executed for the entertainment of the user. The resource may be associated with the game or other software in such a manner that depletion of the resource affects the operation of the game software. For example, the software may be configured so that after a number of uses or a period of time the operation of the game software is altered. To restore operation of the software, the user may request replenishment of the associated resource. The user is thus motivated to repeatedly replenish the resource and thus provide information in response to prompts on multiple occasions. Of course, the same procedures could be applied to business, consumer, and other types of software as well.

Altering operation of software may comprise changing the results of the operation and disabling the operation of the software in whole or in part. Operation of software may be altered in numerous ways, for example, by preventing execution of instructions of the software, by altering, adding to, or making unavailable data utilized by the instructions of the software, by executing additional or different instructions, and so on. The present invention is not limited to a particular manner of altering the operation of software.

It is possible for software, when executed, to simulate moving objects, including creatures, in a computer system. A simulation of this kind maybe referred to as a sprite. For example, software may simulate a moving cloud, or a swimming fish. The software may simulate when the fish is “hungry”, “tired”, “aggressive”, and so on. In other words, the software may simulate fish-like behavior. The software may also simulate the appearance, sound, and motion of the fish. For example, software may simulate the appearance of a fish, fish-like sounds, and how a fish moves. The sprites simulated by software need not exist in the physical world, but may be entirely fanciful. The simulation of the sprite may be altered, and in order to restore the simulation to normal operation, the user may request to replenish a resource of which depletion affects the operation of the software. In one embodiment, the resource to replenish is associated with providing a sprite with “food”, “water”, or other simulated forms of energy or sustenance.

While certain features of the invention have been illustrated as described herein, many modifications, substitutions, changes and equivalents will now occur to those skilled in the art. It is, therefor, to be understood that the appended claims are intended to cover all such embodiments and changes as fall within the true spirit of the invention.

What is claimed is:

1. A method comprising:
altering operation of software;
prompting a user of the software for information;
communicating the information to a server via a request message; and
restoring operation of the software as a result of a response message received from the server.

2. The method of claim 1 further comprising:
depleting an attribute in response to operation of the software;
altering operation of the software in response to depletion of the attribute;
replenishing the attribute in response to the response message; and
restoring operation of the software in response to replenishing the attribute.

3. The method of claim 2 in which the software comprises a sprite and altering operation of the software comprises altering or disabling operation of the sprite.

4. The method of claim 3 in which depleting the attribute further comprises:
depleting the attribute according to operation of a behavior of the sprite.

5. The method of claim 3 in which the software is operated in accordance with a screen saver.

6. The method of claim 3 in which the software is operated in accordance with a game.

7. The method of claim 3 in which the attribute is depleted in accordance with providing sustenance to the sprite.

8. The method of claim 2 in which altering operation of the software further comprises:
disabling operation of the software.

9. The method of claim 2 in which prompting a user of the software for information further comprises:
prompting for first information upon a first depletion of the attribute; and
prompting for second information different from the first information upon a second depletion of the attribute.

10. The method of claim 2 in which in which prompting a user of the software for information further comprises:
providing an option for the user to skip providing the information when providing the information is optional to replenish the attribute.

11. The method of claim 1 further comprising:
providing an advertisement in the response message.

12. The method of claim 1 in which the request message and response message are transmitted via email.

13. The method of claim 9 further comprising:
disabling depletion of the attribute once all of a set of information has been prompted for and once all required information of the set has been provided.

14. The method of claim 1 in which the response message comprises:
at least one of data and instructions which, when applied to the software, result in restoration of the operation of the software.

15. The method of claim 10 further comprising:
prompting for second information when the user selects to skip providing the information.

16. A method comprising:
altering operation of software;
communicating a request message to a server, the request message requesting restoration of the operation of the software; and
restoring operation of the software as a result of a response message received from the server, the response message comprising an advertisement.

17. The method of claim 16 further comprising:
depleting an attribute according to operation of the software;
altering operation of the software in response to depletion of the attribute;
replenishing the attribute in response to the response message; and
restoring operation of the software in response to replenishing the attribute.

18. A method comprising:
receiving a message from a client device requesting restoration of the operation of software comprised by the client device;
forming a reply message comprising an advertisement and at least one of instructions and data which, when applied to the software, result in restoration of its operation; and
communicating the reply message to the client device.

19. The method of claim 18 further comprising:
the message received from the client device identifying a resource of the software to replenish; and
the least one of instructions and data, when applied to the software, resulting in replenishment of the attribute.

20. The method of claim 19 further comprising:
the message received from the client device comprising information provided by a user of the client device in response to a prompt from the software; and
storing the information in a manner associated with the user.
